(19) United States
(12) Patent Application Publication
(10) Pub. No.: US 2026/0199172 A1
(43) Pub. Date: Jul. 16, 2026

(54) FINGER EXOSKELETON

(71) Applicant: GEORG-AUGUST-UNIVERSITÄT GÖTTINGEN STIFTUNG ÖFFENTLICHEN RECHTS, UNIVERSITÄTSMEDIZIN, Göttingen (DE)

(72) Inventors: Miguel Angel BRAVO CABRERA, Göttingen (DE); Tobias HETTENHAUSEN, Göttingen (DE); Viola BARTELS, Göttingen (DE)

(21) Appl. No.: 19/563,728

(22) Filed: Mar. 11, 2026

Related U.S. Application Data
(63) Continuation of application No. PCT/EP2024/075508, filed on Sep. 12, 2024.

(30) Foreign Application Priority Data
Sep. 12, 2023 (DE) 10 2023 124 508.2

(51) Int. Cl. A61H 1/02; B25J 9/00

(52) U.S. Cl. CPC A61H 1/0288; B25J 9/0006; A61H 2201/1215

(57) ABSTRACT

The invention relates to a finger exoskeleton (1) with two exoskeleton members (2, 3) which are connected to one another by pivot bearings. Stops are integrated into the pivot bearing, a stop being able to be integrated into a bearing eye (16, 16b) of an exoskeleton member (2, 3), while the other stop can be formed by a pivot-bearing insert (13). Alternatively or additionally, a fingertip member (5) can comprise a sensor element (42). The sensor element (42) then comprises outer contact elements projecting from the fingertip member (5) to the outside. The outer contact elements extend through recesses of the fingertip member (5). A contact force acting on the outer contact elements can be transmitted via the outer contact elements through the recesses to the fingertip in order to give the wearer of finger exoskeleton (1) haptic feedback regarding the contact force.

### CROSS REFERENCE TO RELATED APPLICATIONS

This application is a continuation of International Application PCT/EP2024/075508 with an international filing date of Sep. 12, 2024 and claiming priority to co-pending German Patent Application No. DE 10 2023 124 508.2 entitled "Finger-Exoskelett", filed on Sep. 12, 2023.

### FIELD OF THE INVENTION

The invention relates to a finger exoskeleton which can be used in the region of at least two arbitrary finger phalanges and for any finger including the thumb.

A finger exoskeleton is a mechanical external supporting structure worn on a finger which can be put on and removed as required. The finger exoskeleton may be an active finger exoskeleton with an (in particular electrical) actuator, or a passive finger exoskeleton without an actuator but, in some cases, with springs or integrally formed elasticities. The finger exoskeleton can be configured as a finger orthosis which can serve medical or therapeutic purposes. It is also possible, however, that the finger exoskeleton supports, guides and/or amplifies movements of the finger and/or relieves finger phalanges and/or joints of the finger and/or protects them against injury or irritation. One possible example of use of such a finger exoskeleton is an assistive support of an assembly worker during assembly work.

### BACKGROUND OF THE INVENTION

The company Ottobock SE & Co. KGaA sells a thumb exoskeleton under the label “paexo thumb”, cp.

https://ottobockexoskeletons.com/paexo-thumb/

(date of inspection: 04.09.2023).

The thumb exoskeleton comprises a first exoskeleton member in which the distal thumb phalanx (phalanx distalis) is received. The first thumb phalanx (phalanx proximalis) is received in a second exoskeleton member. The two exoskeleton members are connected to one another by cranked coupling struts arranged on both sides of the thumb. Full mobility of the distal thumb joint is intended to be provided by the elasticity and shaping of the coupling struts, such that the coupling struts form a type of hinge joint. In order to protect the fingertip of the distal thumb phalanx against mechanical biases, the first exoskeleton member covers the fingertip in the region of the end face and underside. The accommodation of the distal thumb phalanx with the fingertip in the first exoskeleton member is comparable here to a thimble. Furthermore, the first exoskeleton member comprises a support ring on the underside. The thumb exoskeleton is intended to relieve the thumb and, in particular, the distal thumb joint and the carpometacarpal joint of the thumb by diverting forces into the entire hand. The thumb exoskeleton is used for clipping, inserting or stuffing during assembly. The thumb exoskeleton can also be worn under a glove. The thumb exoskeleton is available in different sizes and, as a result of elasticity of the receiving openings of the exoskeleton members for the thumb phalanges, makes rapid putting on and taking off possible.

A generally corresponding embodiment is known from US 2021/0267782 A1, it additionally being mentioned there that the cranked coupling struts on both sides of the thumb can also ensure a limitation of the pivot angle of the distal thumb joint. Furthermore, US 2021/0267782 A1 proposes that a tool can be mounted or formed at the end face on the first exoskeleton member of the thumb exoskeleton, this tool preferably being a cable connection holder, a screwing tool, a wrench, a pressing aid or the like. According to US 2021/0267782 A1, the components of the thumb exoskeleton can be produced by 3D printing, injection molding or in a laminating process.

US 2021/022899 A1 discloses a finger orthosis with two or three orthosis members which are connected to one another by joints. On both sides of the finger, the orthosis members comprise pivot pins oriented outwardly and defining a pivot axis, which pins are received in correspondingly shaped bearing eyes of the adjacent orthosis member. Assembly of the joints takes place under an elastic deformation of the orthosis members such that the pivot pins are introduced into the bearing eyes. In order to avoid hyperextension, an orthosis member comprises, adjacent to the pivot pin, a projection oriented laterally outward which, in order to limit the pivot angle in the manner of a stop, comes into contact with a stop of the adjacent orthosis member. The stop is formed by the outer contour of the adjacent orthosis member in the surrounding region of its bearing eye.

A further thumb exoskeleton whose degrees of freedom of movement are ensured by the elasticity of the material used is known from the website

https://exo.iturri.com/de/prexer-de

(date of inspection 04.09.2023).

The website

https://www.ruck-produkte.de/produkt-infos

(date of inspection 04.09.2023)

discloses the connection of two orthosis members of a finger orthosis by means of a metallic spiral spring whose spring foot points are in each case firmly connected to an orthosis member of the finger orthosis.

Non-generic document DE 10 2012 002 552 A1 discloses an orthosis for correcting malpositions of body joints, in which a shell part for a foot is connected on one side by a rotary bearing to a splint. A further shell part for a lower leg is fastened to the splint. To form the rotary bearing, the splint comprises, in an end region, a bearing eye with a cylindrical inner surface, in which an outer ring of a rolling bearing is inserted. An axle of a joint piece, which is fastened to the shell part for the foot, is supported on the inner surface of an inner ring of the rolling bearing. A limitation of a pivot angle of the rotary bearing and thus of the shell parts is provided by means of two stop discs, which are likewise arranged on the axle of the joint piece and are arranged between the joint piece and the splint. To limit the pivot angle of the rotary bearing and thus of the shell parts, projections of the stops abut the stops of the splint.

Further non-generic documents DE 100 05 764 A1 (corresponding to US 2003/0093018 A1), DE 10 2018 105 480 A1 (corresponding to EP 3 761 920 B1), DE 10 2022 108 577 B3 and DE 10 2021 118 201 A1 relate to orthoses configured as an elbow splint or as an orthopedic orthosis for a knee or elbow joint, a 3D orthosis joint for a 3D hip joint and a walking orthosis.

### SUMMARY OF THE INVENTION

The finger exoskeleton comprises two exoskeleton members. The exoskeleton members are in each case intended for receiving and supporting an associated finger phalanx. The finger exoskeleton may merely comprise the two exoskeleton members, with the result that the finger exoskeleton is supported on only two finger phalanges. It is also possible, however, that the finger exoskeleton comprises at least one further exoskeleton member by which a further finger phalanx can be supported and/or that the finger exoskeleton is additionally supported (for example by a plate and/or loop) on a palm, the back of a hand or a wrist or another part of the body.

The finger exoskeleton can comprise a pivot bearing which connects the two exoskeleton members to one another for being pivoted about a pivot axis. In the applied state of the finger exoskeleton, the pivot axis of the pivot bearing preferably extends coaxially with the pivot axis of the finger joint by which the two finger phalanges received in the exoskeleton members are connected to one another. The pivot bearing of the finger exoskeleton is configured with a bearing eye and a bearing body arranged in the bearing eye.

In the finger exoskeleton, a minimum or maximum pivot angle of the exoskeleton members (and thus of the finger phalanges) relative to one another can be specified. This can be accomplished in that, upon reaching the minimum and maximum pivot angle, two stops contact each other. The proposed embodiments covers embodiments in which either the minimum pivot angle or the maximum pivot angle is specified by means of two stops. It is also possible, however, that both the minimum pivot angle and the maximum pivot angle of the pivot bearing are specified by at least three stops, preferably four stops.

For the embodiments known from the prior art (cf., for example, US 2021/022899 A1), the provision of stops by means of a projection of an orthosis member oriented outwardly and by an outer contour of the adjacent orthosis member, which contour provides the stop,

is complex in terms of production,

leads to a design with projections and edges which is obstructive in use, and

runs counter to a simple, slim, attractive and inconspicuous design of the exoskeleton.

In addition, with such a design there is the possibility that skin of an adjacent finger or objects in the surroundings of the finger exoskeleton can be pinched between the two stops.

In one embodiment, a stop is formed directly by a bearing eye of an exoskeleton member, in which eye the bearing body of the other exoskeleton member is then received. In this case, the bearing eye can be configured to be multifunctional in that it serves, on the one hand, for guiding the rotational movement, in particular for the rotational guidance of the bearing body, and, on the other hand, provides the stop by which the pivot angle is limited. Preferably, the stop of the bearing eye then comes to bear against a corresponding stop of the bearing body in order to limit the pivot angle.

It is possible for the stops by which the minimum or maximum pivot angle of the pivot bearing and thus of the exoskeleton members is specified to be integrated into the pivot bearing. Preferably, the stops are arranged in an overlap region of material regions of the two exoskeleton members (in particular in the region of overlapping bearing walls of the exoskeleton members). The stops may then be arranged in the overlap region in the interior of these material regions, that is to say within the outer surface of the outer exoskeleton member or of the outer bearing wall and the inner surface of the inner exoskeleton member or the inner bearing wall. The stops therefore do not project beyond the outer surface and inner surface, which leads to an attractive design, small overall dimensions and/or an avoidance of pinching of skin or surrounding objects. It is possible for the stops additionally to be covered toward the outside and/or toward the inside, which can be achieved by an additional protective element, for example a fixing screw, or a covering surface of the component forming the stop, in particular a stop flange of a pivot-bearing insert.

In a particular embodiment, it is possible for the stops to have a distance from the pivot axis which is less than 10 mm, less than 9 mm, less than 8 mm, less than 7 mm, less than 6 mm, less than 5 mm, less than 4 mm, less than 3 mm or even less than 2 mm. Alternatively or cumulatively, it is possible for an inner bearing surface of the bearing eye to have a radius which is less than 10 mm, less than 9 mm, less than 8 mm, less than 7 mm, less than 6 mm, less than 5 mm, less than 4 mm, less than 3 mm or even less than 2 mm.

There are numerous possibilities for the structural configuration of the pivot bearing. The components of the pivot bearing can be formed integrally with the exoskeleton members, so that the bearing eye with a stop is formed integrally by one exoskeleton member and the bearing body with a stop is formed by the other exoskeleton member. It is also possible, however, that at least one additional component is used which can then, for example, form the bearing body or the bearing eye and is firmly mounted on an exoskeleton member.

In one proposal, the pivot bearing is provided in that the bearing body comprises a rotary bearing section. The rotary bearing section comprises a fin which is oriented radially with respect to the pivot axis. A fin surface of the fin then comprises a surface normal which comprises at least one component in the circumferential direction around the pivot axis. This fin surface of the fin then forms a first stop. Furthermore, the rotary bearing section of the bearing body comprises an outer bearing surface which corresponds to a lateral surface of a cylindrical segment. It is possible that, on the one hand, the fin and, on the other hand, the outer bearing surface are arranged at the same axial extension but in different circumferential regions of the rotary bearing section. It is also possible that, on the one hand, the fin and, on the other hand, the outer bearing surface are arranged in different axial sections of the rotary bearing section.

For this configuration of the finger exoskeleton, the bearing eye may comprise an inner bearing surface which corresponds to the lateral surface of a cylindrical segment. The inner bearing surface of the bearing eye is formed in correspondence with the outer bearing surface of the bearing body in order to form a sliding bearing for pivoting about the pivot axis. Moreover, the bearing eye comprises a fin receiving recess which is appropriately formed in order to receive the fin of the bearing body. The fin receiving recess is limited in at least one circumferential direction by a fin stop surface which forms a second stop. The fin receiving recess comprises an extension in the circumferential direction which allows pivoting of the fin of the bearing body in the fin receiving recess that is limited by the first and second stop. The inner bearing surface and the fin receiving recess can be arranged corresponding to the design of the bearing body in the region of the rotary bearing section at the same axial extension.

In the finger exoskeleton, the rotary bearing section of the bearing body is then inserted into the bearing eye. To specify the minimum or maximum pivot angle of the exoskeleton members, the first stop formed by the fin comes into contact with the second stop, which limits the fin receiving recess of the bearing eye in the circumferential direction. During pivoting of the exoskeleton members about the pivot axis, the outer bearing surface of the bearing body is guided in a rotatable manner on the inner bearing surface of the bearing eye.

It is generally possible for the bearing body and the bearing eye to comprise only one fin and one fin receiving recess. Preferably, the bearing body comprises two fins. In this case, the two fins can be connected to one another by two outer bearing surfaces in the form of cylindrical segments. Preferably, the two fins are then arranged offset from one another by 180° in the circumferential direction and the two outer bearing surfaces and fins are located at the same axial extension of the bearing body. In this case, the bearing eye comprises two corresponding inner bearing surfaces and two fin receiving recesses. By using two fins and two fin receiving recesses, the forces at the stops when contact of the stops is reached at the minimum and/or maximum pivot angle can be distributed, such that in the ideal case the stop forces are halved. It is also possible for more than two fins and fin receiving recesses (or even a type of toothing with a play in the circumferential direction) to be used if a further reduction of the stop forces is desired.

As explained above, the components of the pivot bearing and in particular the bearing body can be formed integrally by the exoskeleton members. In one proposal, however, the pivot bearing comprises a pivot-bearing insert which forms the bearing body. In this way, separate production of the pivot-bearing insert is possible. By the configuration and production of the pivot-bearing insert, individual adjustment of the pivot bearing can then be carried out and, under certain circumstances, influence can also be exerted (for example by variation of the circumferential extent of the fins) on the minimum and/or maximum pivot angle. The same or different pivot-bearing inserts can then be used for different exoskeleton members. Furthermore, it is made possible for the pivot-bearing insert to be manufactured from a different material than the exoskeleton members. For example, the pivot-bearing insert can be specifically manufactured from a material which has high strength and also allows, for example, reliable engagement of a screw, while the material of the exoskeleton members is specifically provided with an elasticity, a reduced strength or a material feel and surface suitable for a contact on the one hand on the inner side with the finger and on the other hand on the outer side for interaction of the finger exoskeleton with objects.

There are numerous possibilities for the configuration of the pivot-bearing insert and its bearing body. The bearing body of the pivot-bearing insert may comprise the rotary bearing section explained above, on the one hand with at least one fin and, on the other hand, with at least one outer bearing surface. Additionally, in one proposal, the bearing body may also comprise a fixing section. In the region of the fixing section, the bearing body can then be fastened to the exoskeleton member which does not form the bearing eye. For example, in the fixing section the bearing body can have a non-round cross-section which can then be received in a fixing recess of the exoskeleton member which does not form the bearing eye, in a form-fitting manner in the circumferential direction about the pivot axis. It is possible here that, by the interaction of the fixing section with the fixing recess only rotational securing takes place, while an axial degree of freedom remains between the bearing body of the pivot-bearing insert and the exoskeleton member which does not form the bearing eye. The degree of freedom can then be eliminated by other measures, in particular an additional fixing element or a screw. It is also possible, however, that the fixing section of the bearing body of the pivot-bearing insert is pressed into a fixing recess of the exoskeleton member which does not form the bearing eye, or is additionally fastened and secured in the axial direction in the fixing recess in a different way, for example by an adhesive.

In one proposal, the bearing body of the pivot-bearing insert comprises, in the fixing section, a fixing fin. In this case, the exoskeleton member which does not form the bearing eye comprises a fixing recess which comprises a fixing-fin receiving recess. The fixing fin of the bearing body is then arranged in the fixing-fin receiving recess so as to form a rotation-proof connection.

In one embodiment of the finger exoskeleton, the pivot-bearing insert comprises an insert supporting surface. The insert supporting surface may, for example, be configured as a flange, collar or projection. By means of the insert supporting surface, the pivot-bearing insert is then supported in one axial direction (which corresponds to the direction of the pivot axis, preferably outward) on an exoskeleton member, which is preferably the exoskeleton member that comprises the fixing recess and does not form the bearing eye.

In a further refinement of this solution concept, it is proposed that the pivot-bearing insert is secured to at least one exoskeleton member by a fixing element. Preferably, the fixing element secures the pivot-bearing insert in the other axial direction, i.e. counter to the support of the pivot-bearing insert via the insert supporting surface, or inward. It is possible for a fixed connection between the pivot-bearing insert and the exoskeleton member forming the fixing recess to be created by the insert supporting surface, the fixing element and the reception of the fixing section in the fixing recess.

There are numerous possibilities for configuring the fixing element. For example, the fixing element may be a latching or locking connection, a clamping connection, a connection produced by pressing or a connection produced by bonding. In one proposal, the fixing element is a fixing screw. Preferably, in this case a head of the fixing screw serves to secure the pivot-bearing insert to the associated exoskeleton member in the axial direction in which no securing takes place by the insert supporting surface (in particular inward).

It is possible for the connection of the two exoskeleton members to be provided solely by a pivot bearing arranged on one side of the finger. Preferably, however, in a further proposal, pivot bearings are arranged on each side of the finger exoskeleton, the two pivot bearings then having collinear pivot axes. In this way, greater reliability and improved guidance of the exoskeleton members during pivoting can be ensured.

A further proposal is devoted to the strength of the stops and to the transmission and absorption of force at the stops. If the stop surfaces formed, on the one hand, by the fin and, on the other hand, by the fixing-fin receiving recess and limiting the pivot angle of the pivot bearing have surface normals that are oriented tangentially in the circumferential direction, the stop forces are oriented in a plane perpendicular to the pivot axis. In this way, with respect to the pivot axis, a radial loading is produced on the bearing body and, additionally, a moment acts as a result of the radial offset of the fin stop surface and the fin surface with respect to the pivot axis, this moment generating a torsional moment about the pivot axis. In one embodiment, a changed loading of the components of the pivot bearing can be brought about upon reaching contact of the stops if the fin surfaces and the fin stop surfaces are inclined with respect to a plane spanned by the pivot axis and an axis which, oriented radially with respect to the pivot axis, runs through the fin surfaces. Here, an acute inclination angle (for example in the range from 2° to 45°, in the range from 4° to 30°, in the range from 5° to 80°, in the range from 10° to 20°, in the range from 10° to 30°, in the range from 15° to 30°, in the range from 25° to 40°, in the range from 30° to 50°, in the range from 40° to 60°, in the range from 45° to 70°, in the range from 50° to 80° or in the range from 65° to 80°) is used. This inclination angle is obtained, in particular, when the fin surface and the fin stop surface are projected onto a longitudinal plane of the bearing body which contains the pivot axis and is oriented perpendicularly to the radial orientation of the fin surface. The inclination of the fin surface and of the fin stop surface has the effect that the stop forces are divided into one component which runs in the plane oriented transversely to the pivot axis and another component which runs in the axial direction, i.e. parallel to the pivot axis. The first-mentioned component is reduced by this division, with the result that the loading by this component is reduced. Instead, an axial force component is generated, which can be absorbed at other locations, preferably in a contact region of a head of a fixing screw and/or in the region of a support of the insert supporting surface. Here, appropriate measures can then be taken in order to ensure suitable absorption and stiff and reliable support of this axial force component, in that, for example, the size of the contact surface of the head of the fixing screw and/or the size of the insert supporting surface is suitably selected.

For a particular embodiment of the finger exoskeleton, the bearing body of the pivot bearing insert is inserted with the rotary-bearing section from the inside, that is, from the side of a bearing wall facing the finger, into the bearing eye formed by the bearing wall of a second exoskeleton member. The bearing body of the pivot bearing insert is then supported from the inside to the outside via the insert support surface on the bearing wall of the second exoskeleton member. The bearing body of the pivot bearing insert extends with the fixing section (on the side facing away from the insert support surface) out of the bearing wall of the second exoskeleton member. On the outer side of the bearing wall of the second exoskeleton member, this fixing section is then connected, by means of the fixing section, in the fixing recess of the bearing wall of the first exoskeleton member. By means of this connection, as explained, preferably exclusively a rotational fixing, or also a rotational securing, can be provided. The fixing screw is then screwed into the outer end face of the bearing body. The fixing screw comprises a head which secures the pivot bearing insert against disassembly toward the inside. It is possible that the fixing section transitions via a shoulder into the rotary-bearing section and that the bearing wall of the exoskeleton member comprising the fixing section is captured between this shoulder and the head of the fixing screw. In this way, with corresponding tightening or sufficient press-fitting of the fixing screw, the pivot bearing insert is fixed to this exoskeleton member. The rotary-bearing section then projects, optionally together with the insert support surface, inwardly from this exoskeleton member. The other exoskeleton member is then rotatably mounted on this projecting part of the pivot bearing insert.

In a particular embodiment of the finger exoskeleton, at least one of the exoskeleton members comprises a cover. By means of the cover, the fixing element is (partially or completely) covered. The cover can serve, for example (alternatively or cumulatively), the following purposes:

It is possible that the cover prevents the fixing element from exiting the exoskeleton member if, for example, the connection between the fixing element and the pivot-bearing insert unintentionally loosens. If such an unintentional loosening occurs when the finger exoskeleton is subjected to, under certain circumstances, considerable forces, the fixing element could even exit from the exoskeleton member at a speed which could lead to loss of the fixing element or also to injuries.

It is also possible that the cover provides an (in particular smooth) outer surface of the exoskeleton member in the region of the fixing element which is optimized for contact with an adjacent finger, an adjacent exoskeleton member or the surroundings.

There are numerous possibilities for the structural configuration of the cover, the cover also being able to be formed separately from a main body of the exoskeleton member and able to be mounted on the main body in any desired way. In a particular proposal, the cover is formed integrally with the exoskeleton member. Merely to mention one embodiment for the integral formation of the cover, the cover can be configured as a type of pocket which forms an insertion opening. The fixing element can then be introduced, via the insertion opening, in a mounting direction into an interior of the pocket. For this embodiment, it is also possible that an insertion slot opens into the interior of the pocket and into the insertion opening. Preferably, the insertion slot comprises a partial section which is formed outside the pocket and the insertion opening and a further partial section which is arranged in the interior of the pocket. This partial section then provides the end position of the fixing element, in which the fixing element can be mounted to the pivot-bearing insert, the fixing element being able to be arranged in this end position coaxially with the pivot axis of the pivot bearing.

The following further solution can be used alternatively or cumulatively to the embodiments of the finger exoskeleton mentioned above.

For this alternative or cumulative solution, an exoskeleton configured as a finger exoskeleton comprises a fingertip member. The fingertip member here covers, at least partially, the end face of the fingertip and/or an underside of the finger. In the design of finger exoskeletons with such a fingertip member, there may be, according to the prior art, a possible conflict of aims as follows:

In order to ensure support of the end-sided finger phalanx arranged in the fingertip member, the fingertip member is to be configured to be as stiff as possible.

The stiff configuration of the fingertip member then leads to the fingertip member bearing over its full area on the sensitive skin of the fingertip, whereby the sensitive, tactile or haptic feedback of the contact force between the fingertip member and a contacted object is supported in a stiff manner and is not or only to a limited extent transmitted to the fingertip. For good feedback of the contact force to the fingertip, it would therefore be advantageous if the stiffness of the fingertip member were as low as possible.

Against this background, the alternative or cumulative solution proposes that the fingertip member comprises a sensor element. The sensor element comprises an outer contact element arranged on the outside of the fingertip member and an inner contact element arranged on the inside of the fingertip member. The outer contact element serves for a contact of the sensor element with an object contacted, gripped or biased by a force by the finger with the finger exoskeleton. In contrast, the inner contact element serves for providing a contact between the sensor element and the fingertip. The outer contact element is coupled or connected to the inner contact element in such a way that a contact force exerted by the object on the outer contact element is transmitted to the inner contact element, which in turn transmits this contact force via the inner contact element to the fingertip. In order to ensure this, the outer contact element and the inner contact element of the sensor element are jointly displaceable relative to the fingertip member, such that a contact force acting on the outer contact element causes a displacement of the sensor element relative to the fingertip member in inward direction.

This embodiment resolves the conflict of aims mentioned above: The sensor element makes it possible to transmit the contact force in the region of the outer contact element to the fingertip, so that sensitive feedback is ensured during contact of an object with the finger exoskeleton. On the other hand, the fingertip member can be provided with any desired stiffness which is optimized for mechanical support of the finger in the finger exoskeleton, without the sensitive feedback being adversely affected by the degree of freedom of displacement between the sensor element and the fingertip member.

The sensor element can, for example, surround in a U-shape a material web of the fingertip member, the base leg of the U then forming the inner contact element, while the end regions of the side legs of the U, which are remote from the base leg, form two outer contact elements of the sensor element. In a particular proposal, the fingertip member comprises at least one recess through which the sensor element then extends. The delimitation of the recess in the fingertip member can then ensure guidance of the sensor element.

It is possible that the sensor element is rigid under the forces usually generated by the finger, it being understood in particular that, under these acting forces, the sensor element does not experience an elongation which, for example, is greater than 1%, 0.5% or 0.1%. In this case, the sensor element can be displaceable inward against loading by a spring which supports the sensor element on the fingertip member.

Alternatively or cumulatively, it is also possible that the sensor element is elastic. In this case, the elasticity of the sensor element can be used for the displacement of the outer contact element and/or of the inner contact element of the sensor element relative to the fingertip member. It is quite possible that the sensor element comprises partial regions of different stiffnesses.

It is possible that an inner contact element (for example a surface element) which can be curved in accordance with the curvature of the fingertip, is connected to a plurality of outer contact elements, the inner contact element then being able to be connected to the plurality of outer contact elements through a common recess or a plurality of recesses of the fingertip member. The contact forces at the respective locations of the outer contact elements can then be specifically accommodated via the plurality of outer contact elements. The contact forces acting on the outer contact elements are then transmitted as a resultant from the inner contact element to the fingertip. By selecting the number of outer contact elements and the distance and arrangement thereof and the size of the contact surface of the inner contact element with the fingertip, it is then possible to effect a type of transmission of the force transmission, whereby the sensitivity of sensing by the fingertip can be specified structurally in a targeted manner.

It is likewise possible that a plurality of inner contact elements are connected to a common outer contact element (through one or more recesses of the fingertip member).

If a plurality of outer contact elements and inner contact elements are present, these can be displaceable relative to the fingertip member in parallel directions. It is also quite possible, however, that outer contact elements and associated inner contact elements are displaceable in different arbitrary directions relative to the fingertip member. In one embodiment, first groups of outer contact elements and associated inner contact elements can be oriented vertically to the underside of the fingertip, while second groups of outer contact elements and associated inner contact elements are oriented in the lateral direction. The different orientations then make it possible to sense forces in different directions.

Where reference is made here to a plurality of inner contact elements, these may be individual, mutually unconnected inner contact elements or partial inner contact elements which are formed by a common inner contact body, in particular a surface element.

In a particular proposal, outer contact elements can be used in a multifunctional manner in that these outer contact elements also serve to secure the sensor element on the fingertip member. In this case, two pairs of outer contact elements and associated inner contact elements extend through (for example lateral) recesses of the fingertip member on opposite sides. For assembly of the sensor element on the fingertip member, the outer contact elements then have to be moved inward and/or the fingertip member has to be widened in the opposite direction so that inserting of the sensor element with the outer contact elements into the recesses of the fingertip member is possible. The sensor element is then held on the fingertip member in a captive manner as a result of the elastic restoring forces.

In a further proposal, a movement of the sensor element outward and/or inward can be limited by at least one sensor element stop in the finger exoskeleton. If limitation of the sensor element inward takes place, it is possible in this way to prevent excessive loading of the fingertip with force. On the other hand, limiting the movement of the sensor element inward and/or outward can serve to ensure that the sensor element is held in a loss-proof manner on the finger exoskeleton.

In a further proposal, at least one outer contact element and/or at least one inner contact element comprises at least one projection, at least one rib, at least one recess, at least one groove or at least one slot. In this way, raised partial sections of the outer contact element and/or inner contact element can be created, which can provide preferential contact locations of the outer contact element with the object or of the inner contact element with the fingertip. This can improve, on the one hand, gripping of the object and, on the other hand, the sensitive feedback to the fingertip. Alternatively or cumulatively, it is possible that, by means of the projection, the rib, the recess, the groove or the slot, different stiffnesses are provided in the region of the outer contact element and/or inner contact element. It is possible that, in the region of the projection, the rib, the recess, the groove or the slot, the material thickness of the outer contact element and/or inner contact element changes, from which a change in stiffness can result. Alternatively or cumulatively, it is possible that the projection, the rib, the recess, the groove or the slot is formed by an inward or outward bulge or another shaping of the outer contact element and/or inner contact element without a change of the material thickness.

The present invention proposes a finger exoskeleton which is improved in particular with regard to

the structural configuration and/or

the strength and/or

the transmission of force between exoskeleton members and/or

the provision of a pivot bearing and/or

the limitation of the pivot angle of the pivot bearing and/or

assembly and disassembly and/or

the geometry and the design and/or

the interaction with the fingers of the wearer of the finger exoskeleton and/or

the user and wearing comfort and/or

the behavior in the event of failure of the finger exoskeleton in the region of a pivot bearing.

Advantageous developments of the invention result from the claims, the description and the drawings.

The advantages of features and of combinations of a plurality of features mentioned at the beginning of the description only serve as examples and may be used alternatively or cumulatively without the necessity of embodiments according to the invention having to obtain these advantages.

The following applies with respect to the disclosure - not the scope of protection - of the original application and the patent: Further features may be taken from the drawings, in particular from the illustrated geometries and the dimensions of a plurality of components relative to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims which, however, does not apply to the independent claims of the granted patent.

The number of the features mentioned in the claims and in the description is to be understood to cover this exact number and a greater number than the mentioned number without having to explicitly use the adverb "at least". For example, if an element is mentioned, this is to be understood such that there is exactly one element or there are two elements or more elements. Thus, if, for example, reference is made to an outer contact element, this is to be understood such that exactly one outer contact element, two outer contact elements, or more outer contact elements is/are present. The features cited in the claims may be supplemented by further features or may be the only features which the subject matter of the respective claim comprises.

The reference signs contained in the claims are not limiting the extent of the matter protected by the claims. Their sole function is to make the claims easier to understand.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 shows a finger exoskeleton with three exoskeleton members in a perspective view.

FIG. 2 shows the finger exoskeleton according to FIG. 1 in a side view, the finger exoskeleton being in a straightened operating position and, in each case, one outer bearing wall and a fixing screw of the pivot bearings not being illustrated.

FIG. 3 shows the finger exoskeleton according to FIGS. 1 and 2 in a side view, the finger exoskeleton being in a flexed operating position and, in each case, one outer bearing wall and a fixing screw of the pivot bearings not being illustrated.

FIG. 4 shows a perspective exploded view of the finger exoskeleton according to FIGS. 1-3, obliquely from below.

FIG. 5 shows a perspective exploded view of the finger exoskeleton according to FIGS. 1-4, obliquely from above.

FIG. 6 shows, in a perspective view, a pivot-bearing insert of a finger exoskeleton according to FIGS. 1-5.

FIG. 7 shows, in a side view, the pivot-bearing insert according to FIG. 6.

FIG. 8 shows detail VIII of the finger exoskeleton according to FIG. 2 in the region of a pivot bearing.

FIG. 9 shows, in a side view, a finger exoskeleton according to FIGS. 1-5 with the outer bearing walls of the pivot bearings but without fixing screw.

FIG. 10 shows a section X–X of a finger exoskeleton according to FIGS. 1-5 and 9 at the section indicated in FIG. 9.

FIG. 11 shows a detail XI of the sectional illustration according to FIG. 10.

FIG. 12 shows an alternative embodiment of a finger exoskeleton with two exoskeleton members in a perspective view, obliquely from below.

FIG. 13 shows, in a perspective view, obliquely from above, a sensor element of a finger exoskeleton according to FIG. 12.

FIG. 14 shows the sensor element according to FIG. 13 in a perspective view, obliquely from below.

FIG. 15 shows, in a perspective view, obliquely from below, an exoskeleton member configured as a fingertip member with a sensor element.

FIG. 16 shows, in a perspective view and obliquely from above the sensor element according to FIG. 15.

FIGS. 17-21 show a further embodiment of an exoskeleton member of an exoskeleton configured as a finger exoskeleton with associated pivot-bearing inserts and fixing elements, FIG. 17 showing a perspective view and FIGS. 18-21 showing, in perspective views, details in the region of a pivot bearing for different assembly steps.

### DETAILED DESCRIPTION

In the following description of the figures, components and features which correspond or are similar to one another are identified by the same reference numerals, these then being distinguishable from one another by an additional letter a, b, … . In this case, reference may be made to the components and features without the additional letter, in which case one component or one feature, any desired number of components or features or all components or features may be addressed.

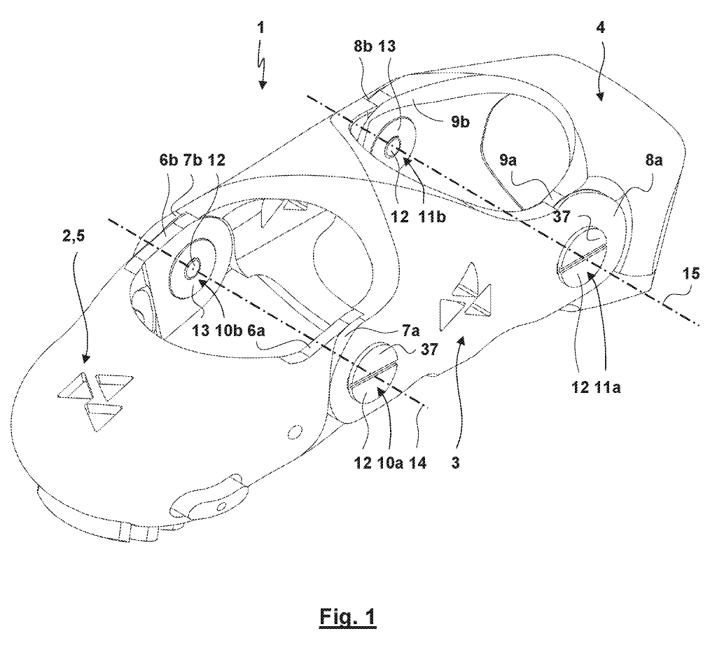

FIG. 1 shows a finger exoskeleton 1. The finger exoskeleton 1 comprises exoskeleton members 2, 3, 4. Exoskeleton member 2 is a fingertip member 5 in which the third finger phalanx (phalanx distalis) is received or accommodated. If the finger exoskeleton 1 is configured (deviating from FIG. 1) not with three exoskeleton members 2, 3, 4 and not for an index finger, middle finger, ring finger and little finger, but with two exoskeleton members 2, 3 and for a thumb, the distal thumb phalanx is received in the exoskeleton member 2.

The second finger phalanx of the index finger, middle finger, ring finger or little finger (phalanx media) or the first thumb phalanx of the thumb is received in exoskeleton member 3.

If the finger exoskeleton is configured with the three exoskeleton members 2, 3, 4, the first finger phalanx of the index finger, middle finger, ring finger or little finger (phalanx proximalis) is received in exoskeleton member 4.

Exoskeleton member 2 surrounds, similarly to a thimble, the fingertip of the third finger phalanx respectively distal thumb phalanx.

Exoskeleton members 3, 4 are configured in the form of a ring, such that they surround the finger phalanx received in the circumferential direction. It is possible here that the ring formed by the exoskeleton member 3, 4 is closed in the circumferential direction or is slotted.

On both sides of the finger,

exoskeleton member 2 forms, in the proximal end region, bearing walls 6a, 6b,

exoskeleton member 3 forms, in the distal end region, bearing walls 7a, 7b and, in the proximal end region, bearing walls 8a, 8b, and

exoskeleton member 4 forms, in the distal end region, bearing walls 9a, 9b.

Bearing walls 6a, 6b and 7a, 7b contact each other in the region of overlaps establishing a sliding contact and establishing parts of pivot bearings 10a, 10b on both sides of the finger. Likewise, bearing walls 8a, 8b and 9a, 9b contact each other in the region of overlaps and establish a sliding contact and parts of pivot bearings 11a, 11b on both sides of the finger.

The pivot bearings 10, 11 each case comprise bearing walls 6, 7, 8, 9 of the exoskeleton members 2, 3, 4 which are connected to one another by the pivot bearing, a fixing screw 12 and a pivot-bearing insert 13.

The pair of pivot bearings 10 comprises a common pivot axis 14. Similarly, the pair of pivot bearings 11 comprises a common pivot axis 15. The pivot axes 14, 15 are preferably oriented parallel to one another.

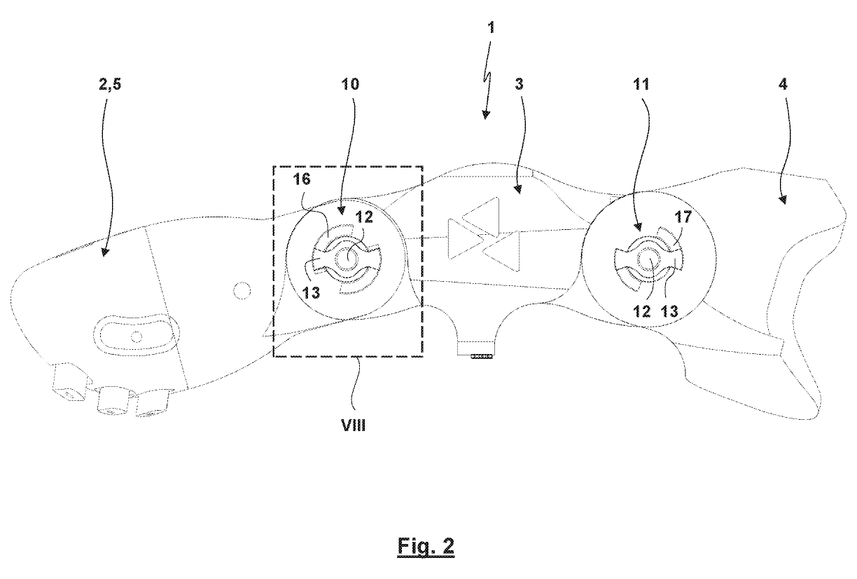

FIG. 2 shows the finger exoskeleton 1 in an extended or straightened position, in which the pivot bearings 10, 11 have reached the maximum pivot angle which (as will be explained in detail below) is specified and limited by stops of the pivot bearings 10, 11.

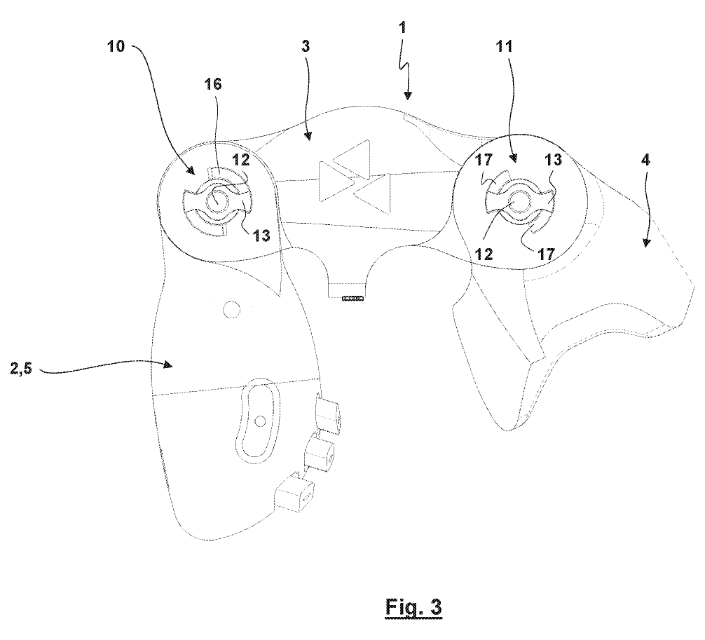

By contrast, FIG. 3 shows the finger exoskeleton 1 in the maximum flexed position, in which the pivot bearings 10, 11 have reached the minimum pivot angle which (as will be explained in detail below) is also specified and limited by stops integrated into the pivot bearings 10, 11.

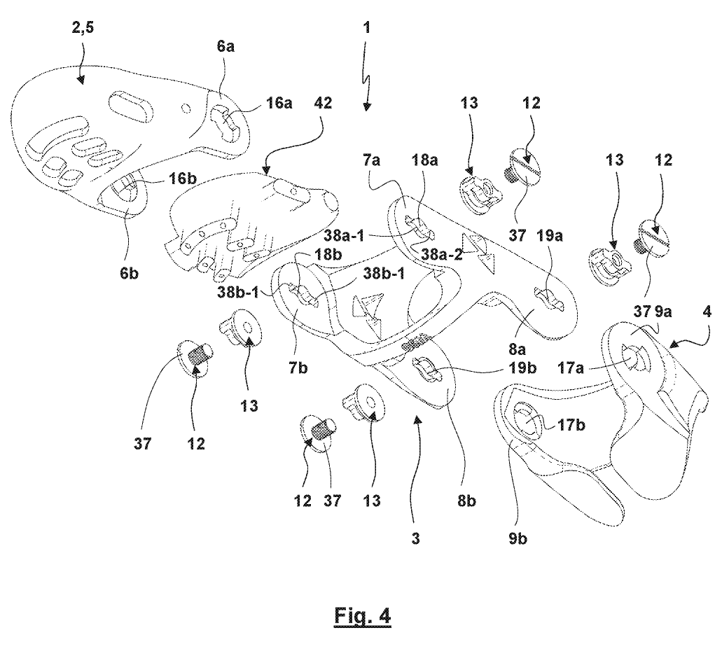

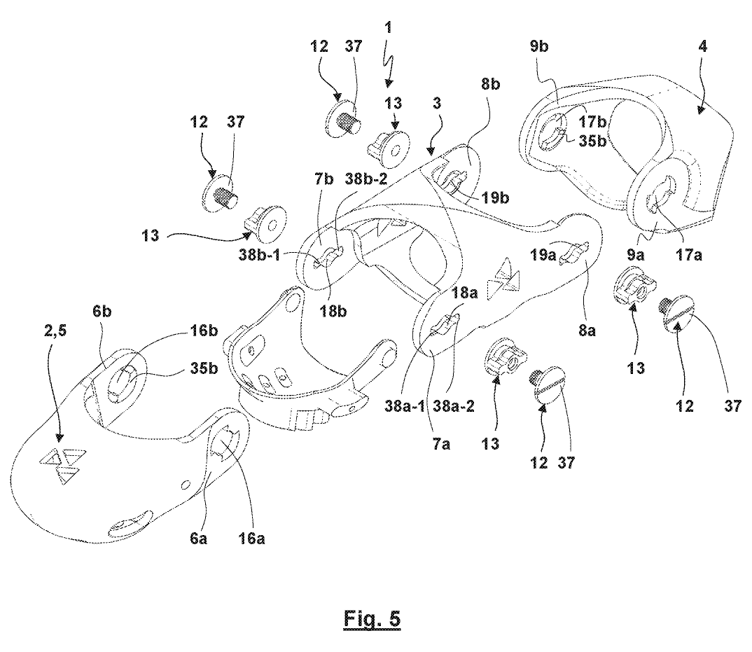

FIGS. 4 and 5 show the finger exoskeleton 1 in perspective exploded views. It can be seen that bearing walls 6 of exoskeleton member 2 comprise continuous bearing eyes 16a, 16b. Similarly, bearing walls 9a, 9b of exoskeleton member 4 comprise bearing eyes 17a, 17b.

Bearing walls 7a, 7b of exoskeleton member 3 each comprise a continuous fixing recess 18. Similarly, bearing walls 8a, 8b of exoskeleton member 3 comprise fixing recesses 19a, 19b.

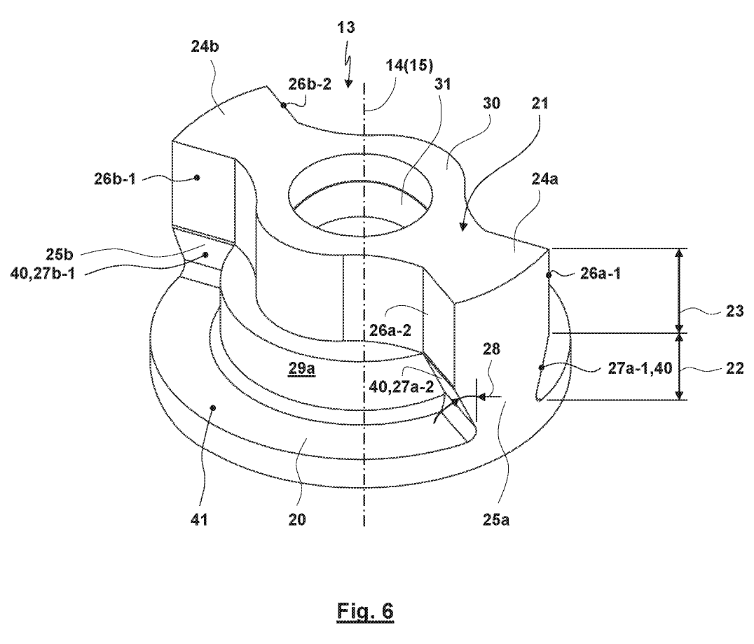

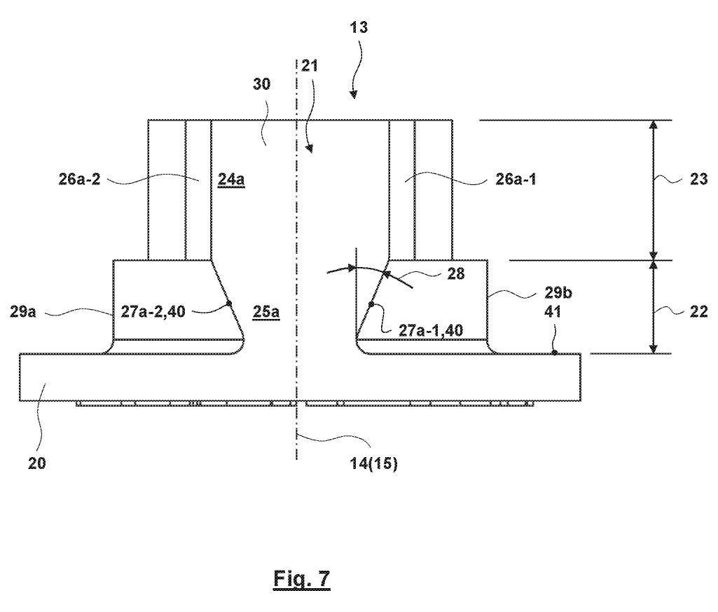

FIGS. 6 and 7 show the pivot-bearing insert 13 as a separate part. The pivot-bearing insert 13 comprises a stop flange 20 in the form of an annular disc which, in the installed state, bears on the wall 6 respectively 9 in the direction of pivot axis 14 or 15 toward the outside. A bearing body 21 is held on the stop flange 20. For the embodiment illustrated, the stop flange 20 and the bearing body 21 are formed in one piece.

The bearing body 21 comprises two longitudinal sections, namely a rotary bearing section 22 and a fixing section 23.

The rotary bearing section 22 comprises fixing fins 24a, 24b which are arranged diametrically opposite to one another with respect to the pivot axis 14, 15.

The rotary bearing section 22 likewise comprises fins 25a, 25b which are arranged diametrically opposite to one another with respect to the pivot axis 14, 15.

Pairs of fins 24, 25 preferably adjoin one another directly in the direction of pivot axis 14, 15 and without formation of a step.

The fixing fins 24 comprise fixing-fin surfaces on both sides which are distinguished from one another by the suffixes “-1” and “-2”. Fixing-fin surfaces 26 are planar and have a surface normal which is oriented in the circumferential direction around the pivot axis 14, 15.

Fins 25 likewise comprise, on both sides, fin surfaces 27, which are distinguished from one another by the suffixes “-1” and “-2”. Fin surfaces 27 are planar. However, fin surfaces 27 are inclined at an inclination angle 28. Here, the inclination angle results between a projection of the pivot axis 14, 15 onto the lateral surface of pivot-bearing insert 13 in the region of the respective fin surface and the projection of the respective fin surface 27 onto the lateral surface. Fixing-fin surfaces 26 transit via a kink into fin surfaces 27.

In the rotary bearing section the fins 25 are connected to one another in the circumferential direction by outer bearing surfaces 29, which are distinguished from one another by the suffixes “-1” and “-2”. Outer bearing surfaces 29 have a shape corresponding to the lateral surface of a cylindrical segment.

In the transition region from outer bearing surfaces 29 to the stop flange 20, a rounding may be present both in the region of the outer bearing surfaces 29 and in the region of fin surfaces 27 (cf. FIG. 7).

In fixing section 23, fixing fins 24 extend from a hollow-cylindrical hub 30. Hub 30 comprises an inner bore 31 which also extends through rotary bearing section 22 and stop flange 20 and is intended for receiving the shank of the fixing screw 12.

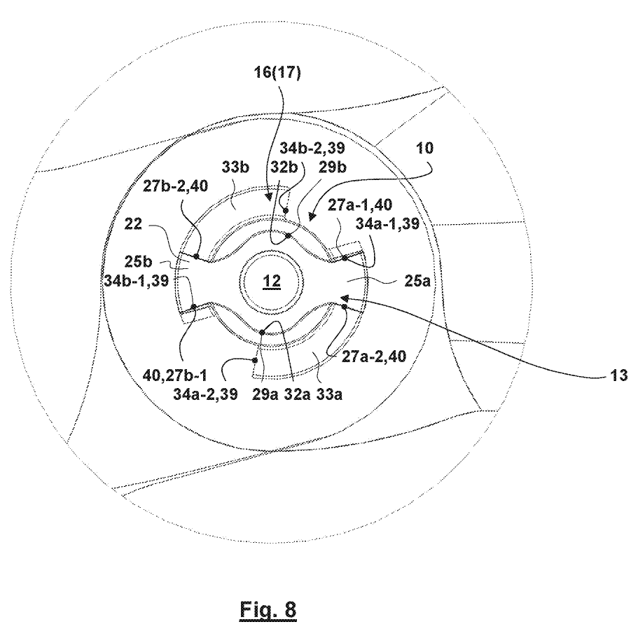

FIG. 8 shows detail VIII of FIG. 2 in the region of pivot bearing 10. Rotary bearing section 22 of bearing body 21 is arranged in the region of bearing eye 16, 17, the extension of the bearing eye 16, 17 corresponding to the extension of rotary bearing section 22 in the direction of the pivot axis. It can be seen that the bearing eye 16, 17 comprises two inner bearing surfaces 32-1 and 32-2 which correspond to the lateral surface of a cylindrical segment. In the circumferential direction between inner bearing surfaces 32-1 and 32-2, fin receiving recesses 33a, 33b are arranged. Fin receiving recesses 33 are configured as a cylindrical segment whose radius is greater than the radius of the cylindrical segment whose lateral surface corresponds to the inner bearing surface 32. In the circumferential direction, fin receiving recesses 33 are limited by fin stop surfaces 34 which are oriented in the radial direction and, similarly to fin surfaces 27, are inclined at an inclination angle 28.

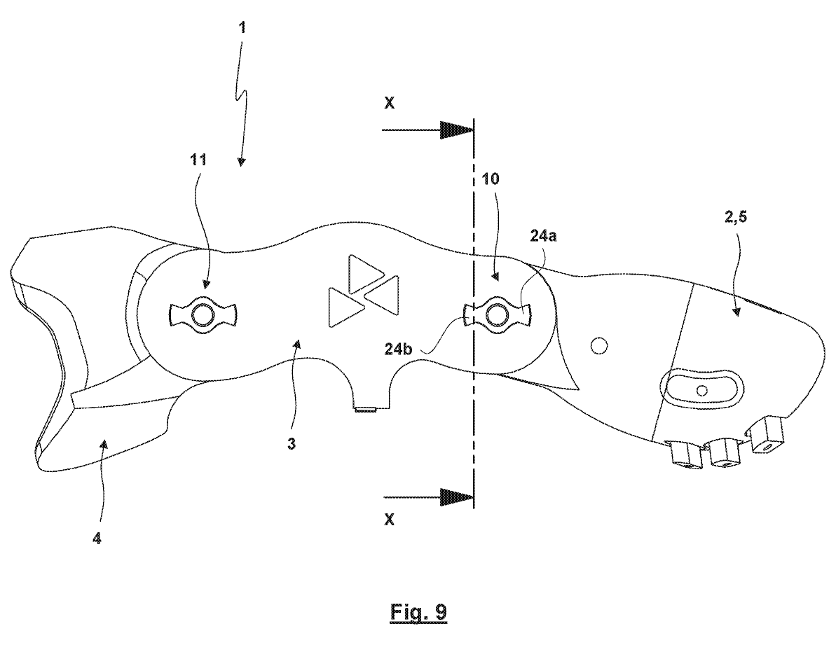

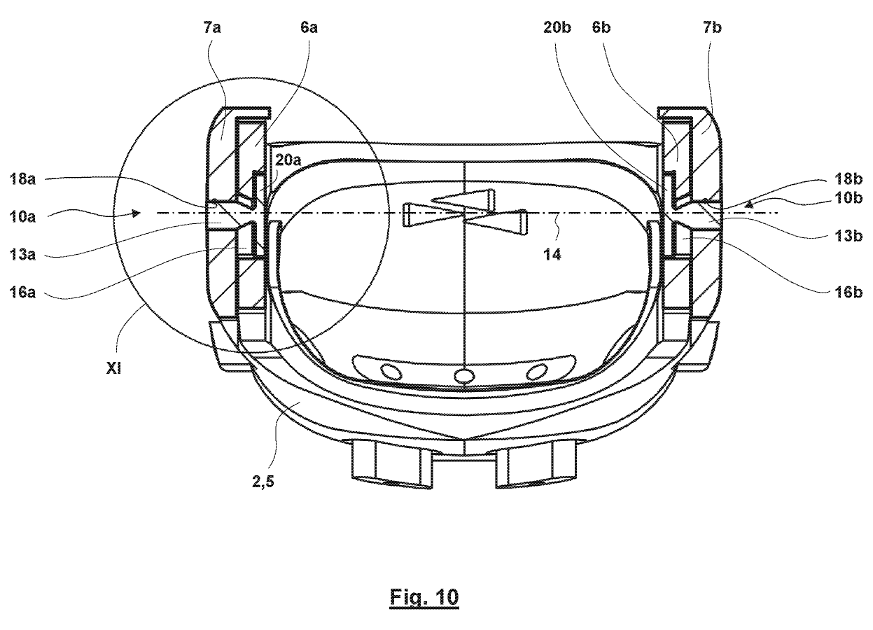

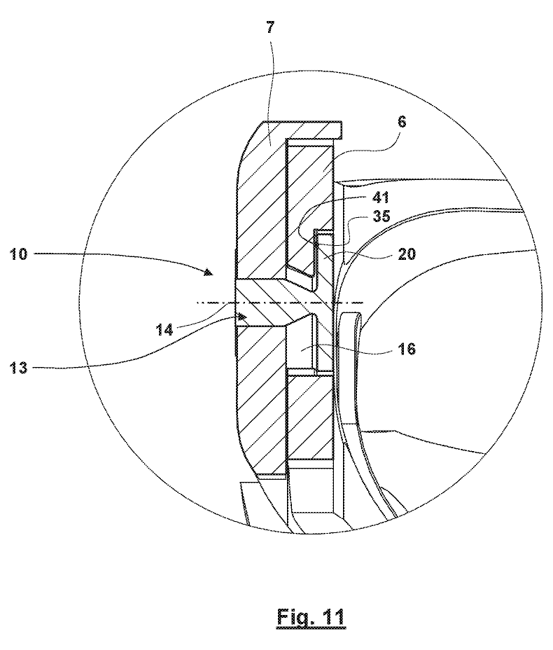

FIG. 9 shows a side view of the finger exoskeleton 1 with an indication of a sectional line X–X. The sectional illustration is reproduced in FIG. 10, FIG. 11 showing detail XI of the sectional illustration according to FIG. 10. In FIGS. 9-11, the pivot bearings 10, 11 are shown without fixing screws 12.

Bearing wall 6 forming the bearing eye 16 is arranged on the inside, that is to say on the side facing the finger of bearing wall 7. On the inner side, bearing wall 6 comprises an accommodation 35 (cf. also FIG. 5) in which stop flange 20 is received such that the end face of stop flange 20 facing the finger is arranged flush with the inner side of bearing wall 6. Rotary bearing section 22 with fins 25 and outer bearing surfaces 29 is arranged in the region of bearing eye 16 and in the region of inner bearing surfaces 32 and fin receiving recesses 33 and fin stop surfaces 34 of bearing eye 16. Fixing section 23 projects outward from bearing wall 6 and extends into fixing recess 18 of bearing wall 7.

The outer end face of bearing body 21 is arranged flush with the outer side of bearing wall 7. Fixing screw 12 is screwed or pressed into this end face (not illustrated in FIGS. 9-11). For this purpose the bearing body 21 can comprise an end-faced bore, and the fixing screw 12 can cut a thread into this bore or catching in this bore when being screwed-in or pressed-in.

The mode of operation of the pivot bearing 10 formed in this way is as follows:

In the axial and outward direction, pivot-bearing insert 13 is secured in the mounted operating position by the contact of stop flange 20 on bearing wall 6 in the region of the accomodation 35. In contrast, axial securing of pivot-bearing insert 13 inward is provided by a contact of a head 37 of the fixing screw 12 on the outer surface of bearing wall 7.

Relative rotation of bearing walls 6, 7 and hence of exoskeleton members 2, 3 about pivot axis 10 is guided by the slinding bearing which is formed by outer bearing surfaces 29 of pivot-bearing insert 13 and inner bearing surfaces 32 of bearing eye 16, that is bearing wall 6.

If a minimum pivot angle, which corresponds to a maximum flexion angle, is reached for pivoting of exoskeleton members 2, 3, fin surfaces 27a-2, 27b-2 come into contact with fin stop surfaces 34a-2, 34b-2, whereby further pivoting in the flexion direction is blocked. Fin surfaces 27-2 and fin stop surfaces 34-2, 34-2 thus form pairs of stops 39, 40.

In contrast, pivoting in the extension direction is blocked for specifying a maximum pivot angle in that fin surfaces 27a-1, 27b-1 come into contact with fin stop surfaces 34a-1, 34b-1. Accordingly, also the fin surfaces 27-1, 27-1 and fin stop surfaces 34-1, 34-1 form stops 39, 40.

Since fin surfaces 27 and fin stop surfaces 34 are inclined at inclination angle 28, the stop force acting on fin surface 27 and fin stop surface 34 is likewise inclined, such that it has a component acting in the axial direction, i.e. parallel to pivot axis 14. This axial force component is oriented such that it leads to an increase in the pressing of stop flange 20 against bearing wall 6. This axial force component therefore does not result in additional bias of the fixing screw 12 with an axial force. Rather, the axial force component can be supported on a comparatively large contact surface of an insert supporting surface 41 between stop flange 20 and bearing wall 6. Preferably, for the embodiment the fixing screw 12 is completely free of forces which are caused by the external loading of finger exoskeleton 1, such that fixing screw 12 serves merely to secure the axial mounting position.

In particular FIG. 4 shows that fixing recess 18 comprises partial sections which correspond to the lateral surface of a cylindrical segment and are connected to one another by fixing-fin receiving recesses 38 which are formed by a radial enlargement of the fixing recess 18. The fixing section 23 of the bearing body 21 is received in fixing recess 18 (in particular with a close fit), fixing fins 24 being received in fixing-fin receiving recesses 38 with as little play as possible and ensuring rotation-proof support of bearing body 21 on bearing wall 7.

Limitation of a minimum and/or maximum pivot angle is provided here by bringing about contact between pairs of stops 39, 40 which are provided, on the one hand, by an exoskeleton member 2 (here bearing eye 16) and, on the other hand, by the other exoskeleton member 3 or pivot-bearing insert 13.

In the preceding description, reference was preferably made to pivot bearing 10 between exoskeleton members 2, 3. The same applies to pivot bearing 11 between exoskeleton members 3, 4.

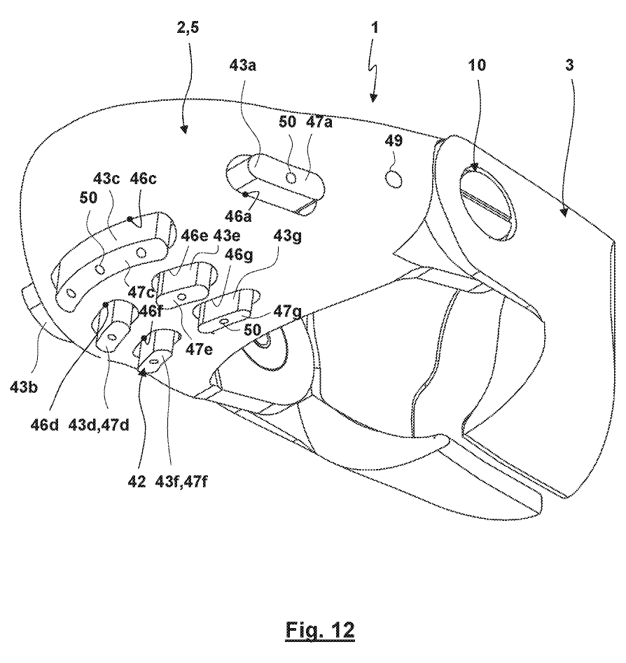

FIG. 12 shows a different embodiment of a finger exoskeleton 1 which (with otherwise corresponding configuration) comprises only two exoskeleton members 2, 3 which are connected to one another by a pivot bearing 10. The finger exoskeleton 1 according to FIG. 12 can, for example, be configured as a thumb exoskeleton or, in the case of another finger, serve exclusively for receiving the second and third finger phalanx.

Optionally, finger exoskeleton 1 according to FIGS. 1-5 or according to FIG. 12 can be provided with at least one sensor element 42. This is explained by way of example for finger exoskeleton 1 according to FIG. 12, the same applying to finger exoskeleton 1 according to FIGS. 1-5.

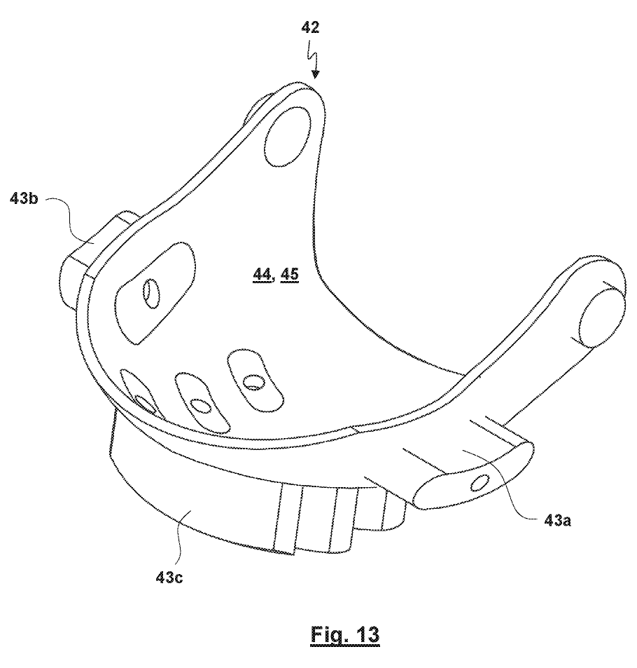

FIG. 13 shows the sensor element 42 as a separate part in a perspective view obliquely from above. The sensor element 42 is of one-piece configuration here, without this necessarily being the case. The sensor element 42 comprises a plurality of outer contact elements 43 and an inner contact element 44. Inner contact element 44 is configured as a curved surface element 45. Surface element 45 comprises a substantially constant wall thickness and is adapted to the shape of the fingertip. Here, surface element 45 covers the underside of the fingertip, at least partially the end face of the fingertip and the lateral side regions of the fingertip.

Outer contact elements 43 extend from the surface element 45 vertically to the surface element 45 and vertically to the fingertip in the associated region.

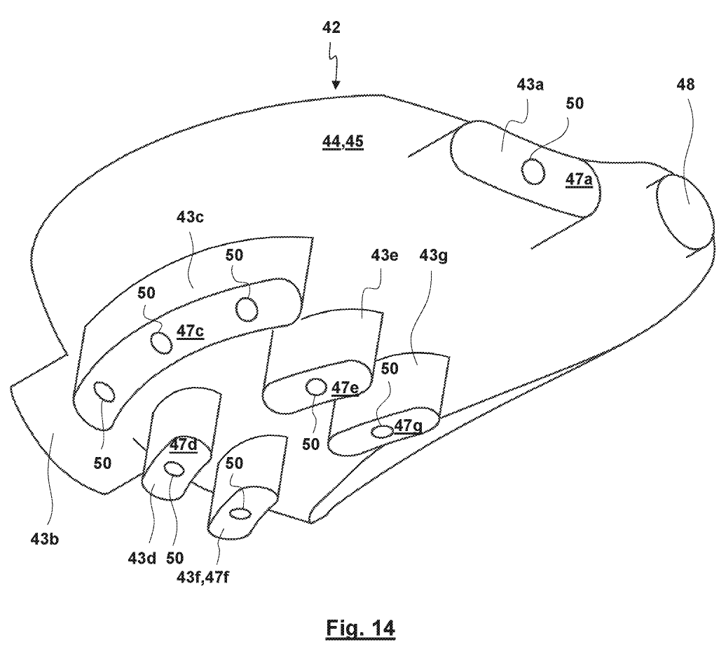

The shape of the outer contact elements 43 can be seen in particular in FIG. 14. On opposite sides, two outer contact elements 43a, 43b are arranged in alignment with one another. The outer contact elements 43a, 43b are arranged in the region of surface element 45 which corresponds to the lateral side region of the fingertip. Outer contact elements 43a, 43b are designed in the form of ribs with rounded ends and, under certain circumstances, with a curved course of the rib. The outer contact elements 43a, 43b extend parallel to the longitudinal axis of the distal finger phalanx.

On the underside, outer contact elements 43c, 43d, 43e, 43f, 43g extend from the surface element 45.

Outer contact element 43c is arranged in the front end region of the underside and oriented transversely, configured in the manner of a rib, preferably with rounded ends and a circular-arc-shaped curvature corresponding to the curvature of the end face of the fingertip.

Parallel to this and with corresponding contouring, pairs of outer contact elements 43d, 43e respectively 43f, 43g are arranged behind the front outer contact element 43c. An interspace or gap remains in each case between these pairs of outer contact elements 43d, 43e respectively 43f, 43g and between the adjacent pairs.

The fingertip member 5 comprises recesses 46. The surface element 45 bears over its full area on the inside against the fingertip member 5. The outer contact elements 43 extend through the recesses 46 and project from the fingertip member 5. End faces of the outer contact elements 43 form contact surfaces 47 thereof.

The sensor element 42 can be of limp or flexible configuration in bending or elastically configured with a constant stiffness or a stiffness varying in different partial sections. If the wearer of the finger exoskeleton 1 contacts an object with the fingertip member 5, the contact surfaces 47 come into contact with the object. The contact force is then transmitted via the outer contact elements 43, to the inner contact element 44, which in turn transmits the contact force to the fingertip, such that the wearer of the finger exoskeleton 1 receives sensitive feedback regarding the contact force. Here, the outer contact elements 43a, 43b transmit a lateral contact force, while the outer contact elements 43d-43g transmit a contact force acting on the underside of the fingertip.

There are preferably the following alternative or cumulative possibilities for assembly and fastening of sensor element 42 on fingertip member 5:

a) If the sensor element 42 comprises outer contact elements 43a, 43b arranged on opposite sides, these can be introduced into the associated recesses 46a, 46b under an elastic compression of the sensor element 42. The elastic restoring force of the sensor element 42 then secures the outer contact elements 43a, 43b in the recesses 46a, 46b.

b) It is also possible for the sensor element 42 to comprise assembly projections 48, which (likewise under elastic deformation of the sensor element 42) can be received in a recess of the fingertip member 5 (which may a blind recess).

c) It is possible that the fingertip member 5 comprises a through recess 49, via which an adjacent contact surface between the sensor element 42 and the fingertip member 5 is loaded with an adhesive medium which then brings about an adhesive connection between the sensor element 42 and the fingertip member 5. It is also possible that through recess 49 is arranged in the region of the connection of an assembly projection 48 with a recess according to b).

It is possible that the sensor element 42 comprises ventilation recesses 50 (preferably in the region of the outer contact elements 43).

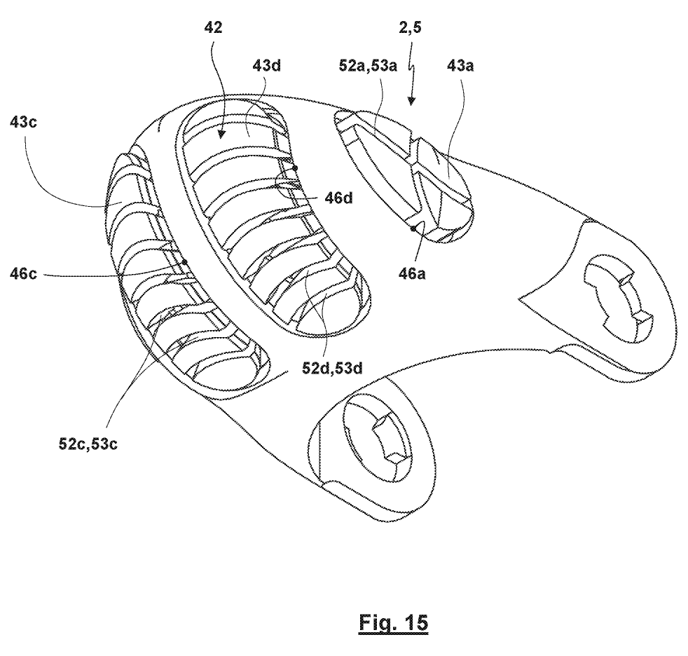

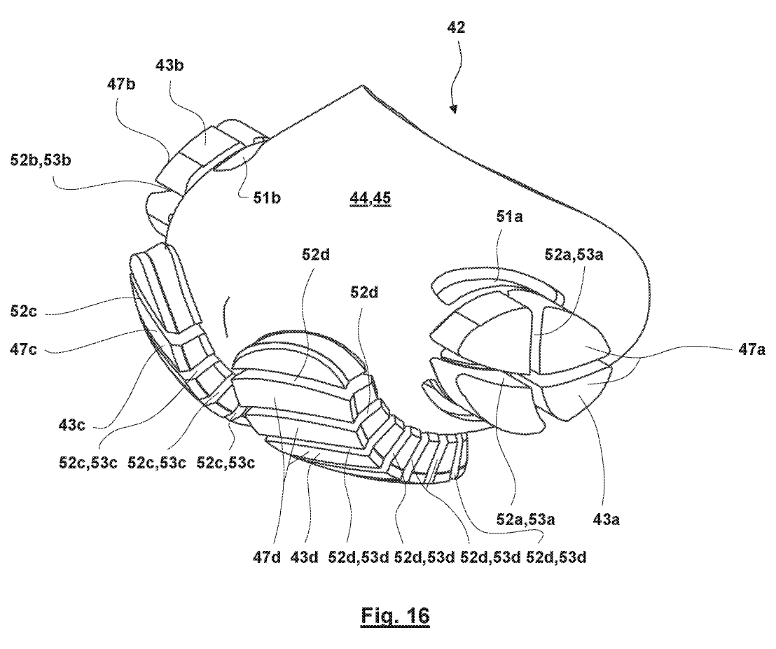

FIGS. 15 and 16 show an alternative configuration of the fingertip member 5 with the sensor element 42. Here, the surface element 45 comprises recesses 51a, 51b adjacent to the outer contact elements 43a, 43b. Via the recesses 51a, 51b deformation paths of the surface element 45 can be specified in a targeted manner and/or the stiffness of the surface element 45 can be influenced.

According to the embodiment in FIGS. 15 and 16, the outer contact elements 43a, 43b, 43c, 43d do not have a continuous end-face contact surface 47. Rather, the outer contact elements 43 comprise recesses 52 (in particular in the form of grooves 53) in the region of the end-face contact surfaces 47 by which the contact surfaces 47 are subdivided into partial contact surfaces. The recesses 52 or grooves 53 can furthermore serve to influence stiffnesses and to provide deformation paths of partial sections of the outer contact elements 43.

As illustrated, it is possible for the outer contact elements 43a, 43b to comprise grooves 53a, 53b which preferably intersect in a cross-shaped manner and/or for the outer contact elements 43c, 43d to comprise grooves 53c, 53d which do not intersect and are preferably parallel.

The pivot joints 10, 11 preferably limit a maximum pivot angle in such a way that no hyperextension or a pivot angle greater than 170°, greater than 175°, greater than 180°, greater than 185°, greater than 190° or even greater than 195° occurs.

The finger exoskeleton 1 and pivot bearings 10, 11 are dimensioned such that forces of up to 400 newtons can act thereon. The stops 39, 40 can also be subjected to the moments resulting from such forces.

The exoskeleton members 2, 3, 4 and, in particular, bearing walls 6, 7, 8, 9 preferably have a material thickness of 1.5 mm (in particular +/- 0.8 mm, +/- 0.5 mm, +/- 0.3 mm or +/- 0.2 mm). The longitudinal extension of pivot-bearing insert 13 in the direction of the pivot axis 14, 15 is twice the wall thickness.

The overall dimension of pivot-bearing insert 13 transverse to the pivot axis 14, 15 is preferably less than 10 mm, less than 9 mm, less than 8 mm or less than 7 mm.

Alternatively or cumulatively, it is possible that the bearing walls do not lie directly against one another, but that a gap or an intermediate space remains between the bearing walls. In this case, the gap or interspace may remain free. It is also possible for pivot-bearing insert 13 to extend into this gap or interspace, the dimension of the pivot-bearing insert in this gap then also being able to be greater than the overall dimensions mentioned above. Providing a free gap or extending the pivot-bearing insert 13 into the gap can, for example, be advantageous in order to compensate for production tolerances, to improve material performance and/or to reduce friction which is intended to oppose pivoting or to generate such friction with a larger radius and lever arm.

The fixing screw 12 is preferably an M2 screw.

The inclination angle 28 has the effect of converting the contact force acting on fins 25 into an axial force which is oriented perpendicularly to the plane of rotation for the relative rotation of the exoskeleton members 2, 3. The axial force can then be reliably supported with a high mechanical strength via the stop flange 20 and the insert supporting surface 41. Here, the axial force generated as a result of the inclination angle 28 acts outward. If a component of the pivot bearings 10, 11 fails, breakage therefore also takes place outward, whereby injury of the wearer of the finger exoskeleton 1 can be avoided. Instead of a fixing screw 12, a pressed-in fixing pin with a head can also be used. By means of the fixing screw 12 or a fixing pin, a core can be provided which can support the other components and at least reduce a deformation of the other parts.

Furthermore, the resistance of the pivot bearings 10, 11 generated by friction can be set via the tightening torque of the fixing screw 12.

It is possible that the components of the finger exoskeleton 1 (in particular the exoskeleton members 2, 3, 4 and/or the pivot-bearing insert 13) are produced by 3D printing from a plastics material, different materials possibly being used for the exoskeleton members 2, 3, 4 on the one hand and the pivot-bearing insert 13 on the other hand. Preferably, the pivot-bearing insert 13 is manufactured from a rigid plastic or a plastic having greater stiffness and strength than that of the exoskeleton members 2, 3, 4.

Guidance of the rotational movement of the pivot bearings 10, 11 can be ensured alternatively or additionally to the guidance by the inner bearing surface 32 and the outer bearing surface 29 via an inner bearing surface of the bearing eye 16, 17 with the outer lateral surface of cylindrical-segment-shaped fins 25, which then form the outer bearing surfaces.

Since the fixing screw 12 does not perform any a relative movement during pivoting relative to, on the one hand, the pivot-bearing insert 13 and, on the other hand, the bearing wall on which head 37 bears, friction and material wear are reduced.

The fixing screw 12 is preferably made of metal.

The fixing screw 12 can also only be pressed into a bore of the pivot-bearing insert 13 without being screwed in.

As a material for the exoskeleton members 2, 3, 4, polyamide (in particular PA11, PA12 and/or a thermoplastic polyurethane) is preferably used, production taking place for example by 3D printing. By contrast, the pivot-bearing insert 13 can be produced by 3D printing from acrylonitrile butadiene styrene.

It is possible that the exoskeleton members 2, 3, 4 are individually adapted to a user with regard to the dimensions, in particular the length and/or diameter, of the finger phalanges. In such individual production, the fin stop surfaces 34 provided by the bearing eyes 16, 17 can likewise be produced individually in order to equip the finger exoskeleton 1 with the individual minimum and/or maximum pivot angle of the wearer. In this case, identical pivot-bearing inserts 13 can be used irrespective of the specific minimum and/or maximum pivot angles to be specified. It is likewise possible that the bearing eyes 16, 17 are not produced specifically, but instead specific production of the arrangement and circumferential extension of the fins 25 of the pivot-bearing insert 13 takes place.

For the embodiments illustrated it is evident that the pivot bearings 10, 11 are basically functional and can absorb and transmit the forces and moments acting on the exoskeleton members 2, 3, 4 and ensure guidance of the pivoting movement even without assembly of the fixing screw 12. For these embodiments, the fixing screw 12 serves merely to secure axial positions of the components of the pivot bearings 10, 11.

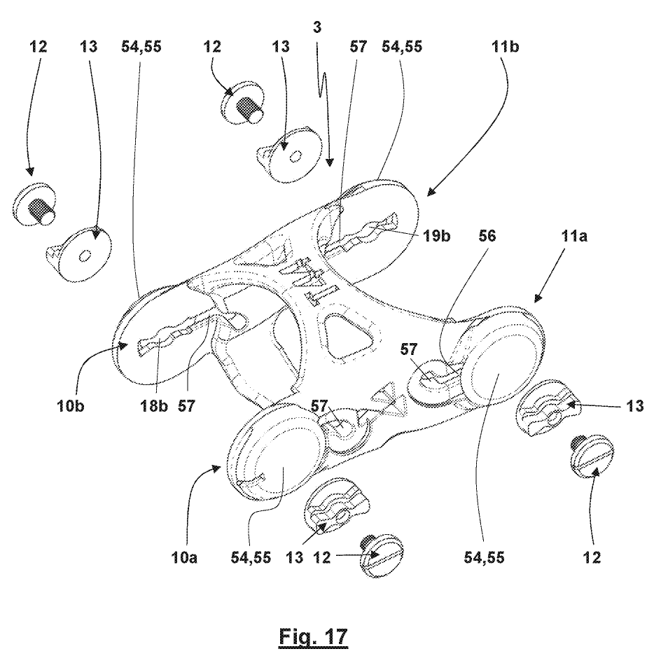

FIG. 17 shows, in a perspective view, a further embodiment of an exoskeleton member 3 which (basically corresponding to the embodiments illustrated above) can be part of a finger exoskeleton 1 with further exoskeleton members 2, 4.

The exoskeleton member 3 comprises a cover 54 in each case in the region of the pivot bearings 10a, 10b, 11a, 11b. For the embodiment illustrated, the cover 54 is formed integrally with the main body of the exoskeleton member 3. For the embodiment illustrated, the cover 54 is configured in the manner of a pocket 55 which has an inner chamber that is accessible via an insertion opening 56 in a mounting direction. An insertion slot 57 opens into the insertion opening 56 and the inner chamber of the pocket 55. The insertion slot 57 also opens into the fixing recess 18, 19. For the embodiment illustrated, the cover 54 is configured in the manner of a disc with a rim curved towards the main body of the exoskeleton member 3, this rim then forming the insertion opening 56. In the description of this embodiment and of the assembly, reference is preferably made to the pivot bearing 10a, the same applying to the pivot bearings 10b, 11a, 11b.

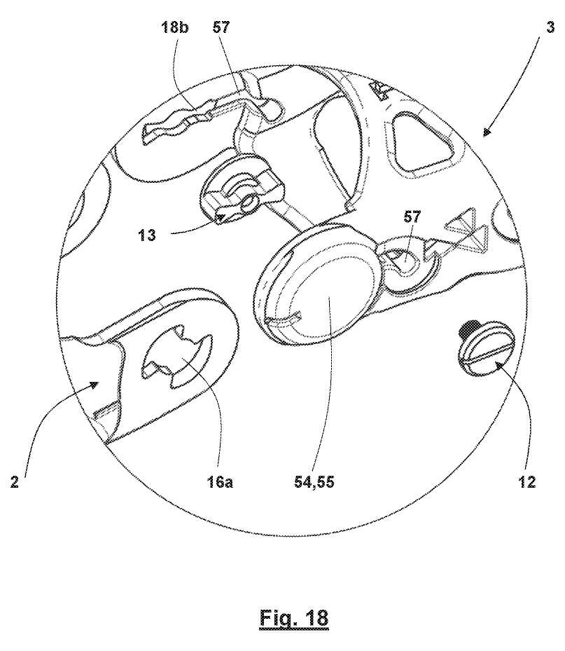

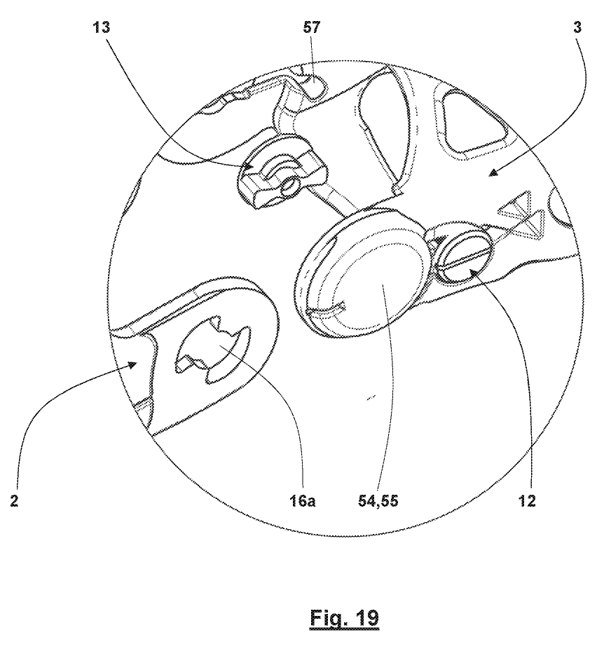

For assembly, a fixing element configured, for example, as a fixing screw 12 is first inserted in the assembly step from FIGS. 18-19 into the partial section of the insertion slot 57 arranged the outside pocket 55 until the fixing screw 12 with the head contacts the lateral boundary of the insertion slot 57 (FIG. 19).

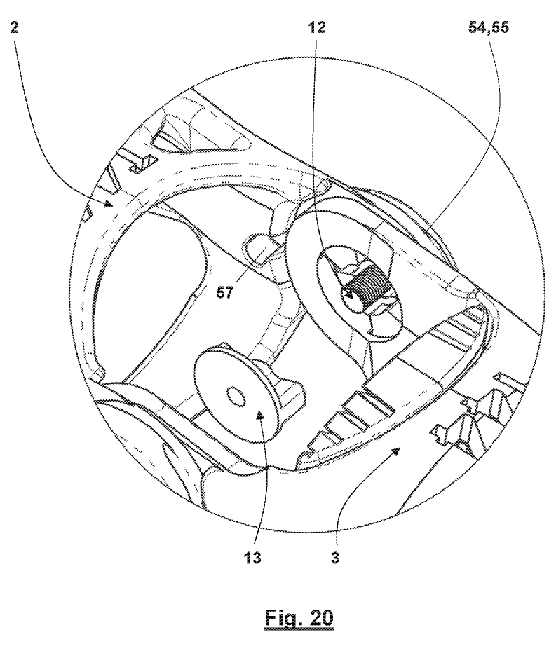

For the next assembly step from FIGS. 19-20, the fixing screw 12 can then be introduced into the interior of the pocket 55 through the insertion opening 56 along the insertion slot 57 until the longitudinal axis of the fixing screw 12 has its intended final position, which corresponds to the pivot axis 14 of the pivot bearing 10, 11.

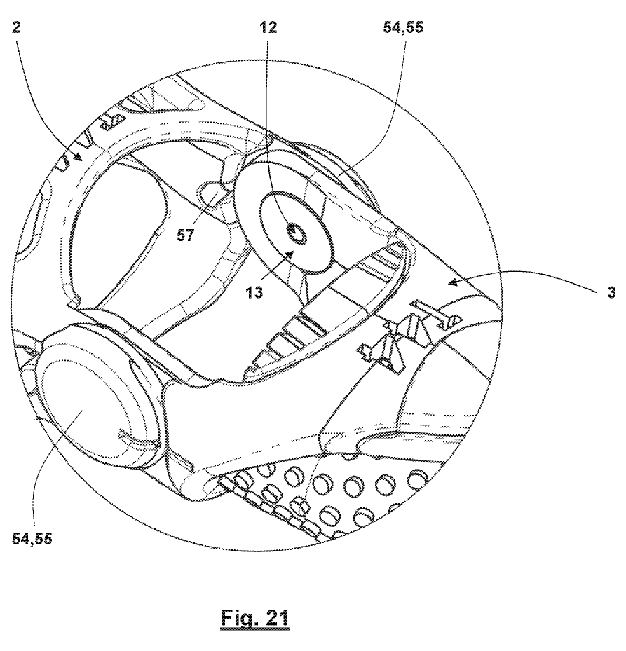

In the next assembly step, the pivot-bearing insert 13 is then introduced into the fixing recess 18, 19, the pivot-bearing insert 13 at the same time being pressed onto the thread of the fixing screw 12. The fully assembled position of the pivot bearing 10, 11 is shown in FIG. 21.

With basically corresponding configuration of the cover 54 and the pocket 55 with the insertion opening 56 and the use of an insertion slot 57, a fixing element which is not configured as a fixing screw 12 can also be used. For example, fastening of pivot-bearing insert 13 to the fixing element can take place via a press connection, a materially bonded connection, a latching connection or a locking connection. For example, the fixing element can also be configured as a press pin or dowel pin which comprises a press section pressed to the pivot-bearing insert 13 and a head.

The cover 54 secures the fixing element on the exoskeleton member 3 and thus on the finger exoskeleton 1. On the other hand, the cover 54 can also ensure desired (in particular smooth) contact conditions of the exoskeleton member 3 with the surroundings, for example an adjacent finger.

With the appended patent claims, the use of the pivot bearings 10, 11 for a finger exoskeleton 1 is claimed. For another application not covered by the present wording of the patent claims, the exoskeleton can also be any exoskeleton which can be used for any desired body part in the region of at least two arbitrary body members. For example, it may be a knee exoskeleton or an elbow exoskeleton. In the present application, reference is preferably made to a finger exoskeleton, the same then applying to an exoskeleton used on another body part.

For another application not covered by the present wording of the patent claims, a pivot bearing configured correspondingly can be used for arbitrary other technical fields in order to connect two members to one another in a pivotable manner about a pivot axis 14, 15. For these other applications, the disclosure applies correspondingly, the following replacements then being made in particular in the patent claims:

replacement of the exoskeleton by a pivot arrangement and/or

replacement of the exoskeleton members by members and/or

replacement of body member or finger member by pivot arrangement part and/or

replacement of fingertip member by sensor member.

In this case, the members do not serve to support a finger phalanx but another object. For example, the members can be load-bearing pivotable components, can be part of a chain of joints, can be part of a hinge arrangement or can be part of the pivot arrangement.

Many variations and modifications may be made to the preferred embodiments of the invention without departing substantially from the spirit and principles of the invention. All such modifications and variations are intended to be included herein within the scope of the present invention, as defined by the following claims.

We claim:

1. A finger exoskeleton comprising
a first exoskeleton member designed and configured for supporting a finger phalanx and
a second exoskeleton member designed and configured for supporting another finger phalanx and
a pivot bearing which connects the first exoskeleton member to the second exoskeleton member for being pivoted relative to each other about a pivot axis,
wherein the pivot bearing comprises a bearing eye and a bearing body arranged pivotably in the bearing eye,
the bearing body comprises a first stop and the bearing eye comprises a second stop, the first stop and the second stop contact each other for limiting a minimum and/or maximum relative pivot angle of the first and second exoskeleton members and
the second stop is integrated into the bearing eye.

2. The finger exoskeleton of claim 1, wherein the second exoskeleton member comprises two bearing walls, the bearing walls comprising the second stop and the bearing eye.

3. The finger exoskeleton of claim 1, wherein
a) the bearing body comprises a rotary bearing section,
b) the rotary bearing section comprises a fin oriented radially with respect to the pivot axis, the fin forming the first stop,
c) the rotary bearing section comprises an outer bearing surface having a shape of a lateral surface of a segment of a cylinder,
d) the bearing eye comprises an inner bearing surface having a shape of a lateral surface of a segment of a cylinder, and
e) the bearing eye comprises a fin receiving recess which is limited in a circumferential direction by the second stop,
f) wherein the rotary bearing section of the bearing body is received by the bearing eye and
g) in order to specify a minimum or maximum relative pivot angle of the first and second exoskeleton member, the first stop formed by the fin comes into contact with the second stop which limits the fin receiving recess of the bearing eye in the circumferential direction, and
h) the outer bearing surface of the bearing body is slidingly guided in a rotatable manner on the inner bearing surface of the bearing eye.

4. The finger exoskeleton of claim 3, wherein
a) the bearing body comprises the rotary bearing surface, another rotary bearing surface, the fin and another fin and
b) the bearing eye comprises the inner bearing surface, another inner bearing surface, the fin receiving recess and another fin receiving recess.

5. The finger exoskeleton of claim 1, wherein the pivot bearing comprises a pivot-bearing insert which forms the bearing body.

6. The finger exoskeleton of claim 5, wherein the pivot-bearing insert comprises a fixing section by which the pivot-bearing insert is fastened to the first exoskeleton member.

7. The finger exoskeleton of claim 6, wherein
a) the pivot-bearing insert comprises a fixing fin in the fixing section,
b) the first exoskeleton member comprises a fixing recess with a fixing-fin receiving recess and
c) the fixing fin is arranged in the fixing-fin receiving recess under formation of a rotation-proof connection.

8. The finger exoskeleton of claim 7, wherein the pivot-bearing insert comprises an insert supporting surface by which the pivot-bearing insert is supported in one axial direction on the first exoskeleton member or second exoskeleton member.

9. The finger exoskeleton of claim 5, wherein the pivot-bearing insert is secured by a fixing element.

10. The finger exoskeleton of claim 8, wherein the pivot-bearing insert is secured by a fixing element.

11. The finger exoskeleton of claim 10, wherein pivot-bearing insert
a) is supported in one axial direction via the insert supporting surface,
b) is secured in the other axial direction by the fixing element, and
c) is connected in a form-fitting manner to the first exoskeleton member with regard to a rotation about the pivot axis.

12. The finger exoskeleton of claim 10, wherein the fixing element is a fixing screw.

13. The finger exoskeleton of claim 1, wherein
a) the pivot bearing is arranged on a first side of the finger exoskeleton,
b) another pivot bearing is arranged on a second side of the finger exoskeleton and
c) the pivot bearing and the other pivot bearing have collinear pivot axes.

14. The finger exoskeleton of claim 1, wherein the first and second stops comprise first and second stop surfaces which are inclined at an inclination angle.

15. The finger exoskeleton of claim 12, wherein
a) the pivot-bearing insert
aa) is inserted with the rotary bearing section from the inside into the bearing eye of the second exoskeleton member,
ab) is supported from the inside toward the outside by the insert supporting surface on the second exoskeleton member, and
ac) extends with the fixing section outward from the second exoskeleton member and is arranged with the fixing section in the fixing recess of the first exoskeleton member,
b) wherein the fixing screw is screwed into an outer end face of the pivot-bearing insert, said fixing screw having a head which secures the pivot-bearing insert against disassembly in inward direction.

16. The finger exoskeleton of claim 9, wherein a cover is provided which covers the fixing element.

17. The finger exoskeleton of claim 16, wherein the cover is formed integrally with the first or second exoskeleton member.

18. The finger exoskeleton of claim 17, wherein the cover is configured as a pocket with an insertion opening into which an insertion slot opens.

19. The finger exoskeleton of claim 1 comprising a fingertip member with a sensor element, the sensor element comprising
a) an outer contact element arranged on an outside of the fingertip member and
b) an inner contact element arranged on an inside of the fingertip member,
the inner contact element being connected to the outer contact element so that the outer contact element and the inner contact element of the sensor element are jointly displaceable relative to the fingertip member.

20. The finger exoskeleton of claim 19, wherein the sensor element extends through a recess of the fingertip member.

21. The finger exoskeleton of claim 20, wherein the sensor element is displaceable inward against a loading by a spring.

22. The finger exoskeleton of claim 19, wherein the outer contact element and the inner contact element are jointly displaceable inward relative to the fingertip member under an elastic deformation of the sensor element.

23. The finger exoskeleton of claim 19, wherein the outer contact element and another outer contact element are connected to the inner contact element.

24. The finger exoskeleton of claim 19, wherein the inner contact element and another inner contact element are connected to the outer contact element.

25. The finger exoskeleton of claim 19, wherein the sensor element and another sensor element are provided which are displaceable in different directions relative to the fingertip member.

26. The finger exoskeleton of claim 19, wherein the sensor element is secured to the fingertip member in that the contact element and another contact element extend on opposite sides through lateral recesses of the fingertip member.

27. The finger exoskeleton of claim 19, wherein a movement of the sensor element is limited by a sensor element stop.

28. The finger exoskeleton of claims claim 19, wherein the outer contact element and/or the inner contact element comprises at least one of a projection, a rib, a recess, a groove, or a slot.
